(19) United States
(12) Patent Application Publication
(10) Pub. No.: US 2002/0194758 A1
(43) Pub. Date: Dec. 26, 2002

(54) System for rotating objet d'art

(76) Inventor: Brian Challis, Sandy, UT (US)

Correspondence Address: Steve M. Perry, THORPE, NORTH & WESTERN, L.L.P., P.O. Box 1219, Sandy, UT, 84091-1219, US

(21) Appl. No.: 09/886,596

(22) Filed: Jun. 21, 2001

(51) Int. Cl. G09F 19/08

(52) U.S. Cl. 40/411

(57) ABSTRACT

A system for rotating an objet d'art (object), includes an outer hollow cylinder in which is rotatably disposed an inner hollow cylinder, and an elongated shaft rotatably disposed in the hollow of the inner cylinder. An electric motor is coupled by a drive belt to a pulley mounted on the inner cylinder, so when the motor is operated, the inner cylinder rotates which, in turn, causes the shaft to rotate. The object is mounted on a top end of the shaft to rotate when the shaft is rotated. Rotation of the shaft and object may be temporarily stopped, reversed or otherwise altered without stopping operation of the motor since the shaft rotates independent of the inner cylinder, while the inner cylinder continues to rotate.

### FIELD OF THE INVENTION

The present invention relates to a system for rotating an objet d'art (object) such as a work of art, particularly, a system for rotating an object wherein the rotation speed and direction may be manually altered, and upon releasing the object eventually resumes automatic rotation. This system of rotating an object allows significant interaction between viewers of the object and the object itself.

### BACKGROUND OF THE INVENTION

Art objects and other objects and devices designed for visual display are typically displayed in a static condition. That is, the object or design to be viewed is positioned so that it does not move and if viewers wish to observe all sides of the object, viewers must walk around the object. However, it may be desirable to provide a device for rotating the object so that a viewer, while remaining stationary, may view all sides of the object. This allows the placement of viewed objects in close proximity to one another, near obstructions, or in a corner since no walking space is required around each displayed object. Also, a more orderly movement of viewers is likely since they can simply move past the objects being viewed in one direction without circling the object. Some objects are simply more pleasing to view when rotating, as opposed to static. The effect of viewing a rotating piece cannot adequately be duplicated by the viewer walking around the object.

A number of devices have been developed over the years for causing motorized rotation of objects. Examples of such devices are disclosed in U.S. Pat. Nos. 1,223,876, 1,865,923, 1,360,856, and 5,255,886. These devices all provide for rotating an object for display, but the objects cannot be stopped for temporary viewing without turning off the power to the motor driving the rotation. Furthermore, these devices do not allow a temporary alteration of rotational direction or speed. Intentional or accidental altering of the rotation of the object in these prior art devices can damage the motor, strip the gears, cause belt slippage, or stress or damage the rotation driving device.

### OBJECTS AND SUMMARY OF THE INVENTION

It is an object of the invention to provide a system for rotating an objet d'art (object) wherein the object may be freely stopped by hand without damaging the system.

It is another object of the invention to provide a system for automatically rotating an object in a manner to allow temporarily stopping rotation.

It is yet another object of the invention to provide a system for rotating an object in a manner that allows temporary alteration of the rotational direction or speed.

The above and other objects are realized in a specific illustrative embodiment of a system for rotating an object. In this embodiment, a cylinder is rotatably disposed in a first hollow. The cylinder includes an elongate second hollow generally coincident with the cylindrical axis of the cylinder.

An elongate shaft is rotatably disposed in the second hollow. The object is mounted on one end of the elongate shaft. A drive means coupled to the cylinder serves to rotate the cylinder in the first hollow thereby causing the shaft and object to rotate. If rotation of the shaft is altered, the cylinder continues to rotate about the shaft.

In other embodiments of the present invention, a low friction interface may be disposed within the second hollow, between the cylinder and the shaft. This low friction interface can be, but is not limited to, a bearing or a lubricant. With this configuration, while the objet d'art is being rotated, it may be manually stopped or otherwise altered for examination or other purposes since the shaft can remain stationary while the inner cylinder rotates about the shaft. Upon release of the objet d'art, the inner cylinder will resume carrying the shaft which causes the shaft and the objet d'art to resume rotating.

### BRIEF DESCRIPTION OF THE DRAWINGS

FIG.1 is a perspective view of a system for rotating an objet d'art according to the present invention; and

FIG.2 is a side cross-sectional view of the system of FIG. 1.

### DETAILED DESCRIPTION

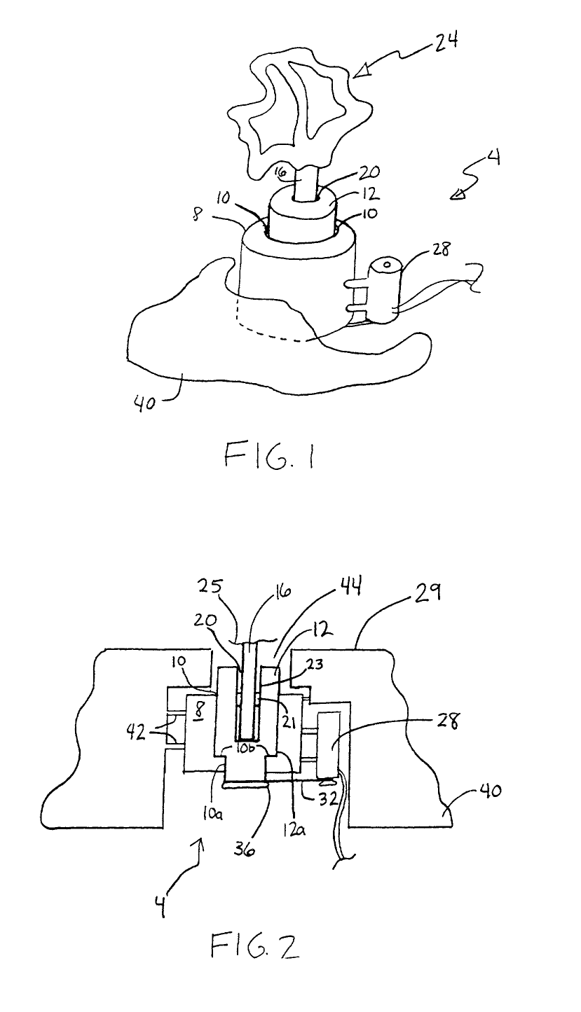

Referring to FIGS. 1 and 2, there is shown a system and method for rotating an objet d'art (object), so that the speed or direction of rotation of the object may be altered without affecting the rotational drive mechanism.

The system includes a type of clutch 4 having an outer hollow cylinder 8 having a cylindrical hollow 10, in which is rotatably disposed an inner hollow cylinder 12.

The hollow 10 optionally includes a reduced diameter portion 10a (FIG. 2) defining shoulders 10b on which rests an enlarged portion 12a of the cylinder 12. A shaft 16 is rotatably disposed in an inner hollow 20 of the inner cylinder 12. Mounted on the upper end of the shaft 16 is an objet d'art (object) 24 such as a sculpture or like design object.

Mounted on the side of the outer cylinder 8 is an electric motor or other power providing device 28 which is coupled by a drive belt 32 (FIG. 2) to a pulley 36 which is coupled to the lower end of the inner cylinder 12 (which protrudes below the bottom end of the cylinder 8) so that when the pulley 36 is rotated, it causes the inner cylinder 12 to rotate. The motor 28 can be powered by conventional batteries (not shown) or by a conventional electrical outlet. It will be apparent to one of skill in the art that a variety of motor types and motor mounting positions could be utilized with the present invention. For example, hydraulic motors and pneumatic motors can likewise be used. Additionally, the transmission of power between the motor 28 and the inner cylinder 12 can be accomplished by belts (as shown in FIGS. 1 and 2), gears, shafts, etc.

When the inner cylinder 12 is caused to rotate, initially, the shaft 16 remains static. However, the inside surface 23 of the inner cylinder 12 is in communication with the surface of the shaft 16 by means of a low friction interface. Sufficient friction is generated between the inside surface 23 of the inner cylinder 12 and the shaft 16 so that the shaft is then rotated by the inner cylinder 12. Over time, the shaft 16 reaches the rotational speed of the inner cylinder 12.

The communication or low friction interface between the inside surface 23 of the inner cylinder 12 and the shaft 16 can be accomplished in a variety of ways. In FIG. 2, low friction bearings 21 are shown between the inside surface 23 of the inner cylinder 12 and the shaft 16. However, a variety of other methods of creating a low friction communication or clutch between the inside surface 23 and the shaft 16 would be apparent to one skilled in the art.

For example, the hollow 20 can be packed with a lubricant such as grease or oil. This creates a low enough friction interface to allow the shaft 16 (or object 24) rotation to be altered, but there is enough friction between the inside surface 23 and the shaft 16 to allow the shaft 16 to resume rotation upon being released.

In another embodiment, the shaft 16 can be in direct communication with the inside surface 23. Both the shaft 16 and/or the inside surface 23 could be made of material having a low friction surface. Examples of low friction surfaces include, but are not limited to plastic such as TEFLON (available from DuPont, Wilmington, Del.), and bronze. Again, such a low friction surface would allow one to alter the rotation of the shaft 16, for example, by grasping the object 24. However, upon releasing the object 24, enough friction would be generated between the two surfaces that eventually the rotation of the inner cylinder 12 would cause the shaft 16 to rotate as before.

It is again noted that since the shaft 16 is rotatably disposed in the hollow 20 of the inner cylinder 12, the rotation velocity or direction of the shaft (and object 24 mounted on the upper end of the shaft) may be altered without altering rotation of the inner cylinder 12. When the shaft 16 (or the object 24) is released, the shaft again rotates with the rotation of the inner cylinder 12 as before.

Preferably, the clutch 4 would be disposed in a base 40 of a sculpture or other work of art (e.g., by brackets or adhesives 42) so that the shaft 16 protrudes through an opening 44 (FIG. 2) in the top of the base 40. Alternatively, the clutch 4 could be recessed into a pedestal or similar support mechanism. In this manner, the clutch is unseen by a person viewing the object 24.

It is further noted that the size of the opening 44 can vary depending on the size of the object at its bottom 25. For example, an object having a wide bottom 25 could be used with a larger opening 44 without the opening 44 and clutch 4 being visible to an observer. In contrast, an object 44 having a narrow bottom 25 would require a smaller opening 44 so that the opening 44 and clutch 4 would not be visible to an observer.

The bottom 25 of the object may be substantially flush with the top surface 29 of the base 40 of the sculpture or other work of art. Alternatively, the bottom 25 of the object may be elevated, upon the shaft 16, above the top surface 29 of the base 40 of the sculpture or other work of art.

In other embodiments, this assembly can be mounted horizontally or even inverted in an orientation such that the object 24 is hanging. Accordingly, the use of terms such as “upwardly”, “top”, “bottom”, “lower opening” and “upper opening” are not intended to limit the orientation of the system, but instead are merely used for convenience.

The system described is comparatively simple and inexpensive to manufacture. The system may be easily transported and provides a simple and efficient device for dynamically displaying an object for exhibition purposes.

While the present invention has been described with respect to its presently preferred embodiment and various modifications thereto, it is to be appreciated that still other modifications may be made without departing from the spirit and scope of the invention. It is accordingly contemplated that the following claims should be interpreted so as to include all those equivalent embodiments within the spirit and scope thereof.

What is claimed is:

1. A system for rotating an object, comprising:
means for defining a first hollow,
a cylinder rotatably disposed in the first hollow, and including an elongate second hollow generally coincident with the cylindrical axis of the cylinder,
an elongate shaft rotatably disposed in the second hollow wherein the object is mounted on one end of the elongate shaft, and
drive means coupled to the cylinder for rotating the cylinder in the first hollow to cause the shaft and object to rotate, such that when rotation of the shaft is altered, the cylinder continues to rotate about the shaft.

2. A system as in claim 1 further including a base having a top, a cavity formed therein, and an opening extending from the cavity out the top, wherein said first hollow defining means is disposed in the cavity so that said one end of the shaft extends through said opening.

3. A system as in claim 1 wherein said first hollow defining means comprises a generally cylindrical body in which is formed said first hollow which includes an upper opening through which said cylinder may be inserted into the first hollow, and a lower opening, smaller than said upper opening so that the cylinder may not pass therethrough.

4. A system as in claim 3 further including a drive pulley mounted on an end of the cylinder to protrude out the lower opening of the first hollow, wherein said drive means comprises a motor having a drive pulley, and a drive belt threaded about the drive pulley and driven pulley to cause rotation of the driven pulley when the motor is operated.

5. A system as in claim 1 further comprising a low friction interface within the second hollow, disposed between the cylinder and the shaft.

6. The system of claim 5 wherein the low friction interface is a bearing.

7. A system as in claim 4 wherein said motor is mounted on the side of the body.

8. A system for rotating an object comprising:
an outer hollow cylinder defining a first hollow,
a cylinder rotatably disposed in the first hollow, and including an elongate second hollow generally coincident with the cylindrical axis of the cylinder,
an elongate shaft rotatably disposed in the second hollow wherein the object is mounted on one end of the elongate shaft,
a low friction interface within the second hollow, disposed between the cylinder and the shaft, and
drive means coupled to the cylinder for rotating the cylinder in the first hollow to cause the shaft and object to rotate, such that when rotation of the shaft is altered, the cylinder continues to rotate about the shaft.

9. The system of claim 8 wherein the low friction interface is a bearing.

10. A method of dynamically displaying an objet d'art object, comprising the steps of:
providing a base having a hollow formed therein and an opening to the hollow at the top of the base;
rotating a hollow cylinder in the hollow of the base which projects upwardly through the base opening, wherein the cylinder includes a central hollow, open at the top of the cylinder, which is generally coincident with the cylindrical axis of the cylinder,
rotating a shaft mounted in the hollow of the cylinder by a low friction interface, a top end of the shaft extending upwardly through the cylinder opening; and
mounting the object on the shaft in such a manner that the object and shaft rotation may be manually altered temporarily while the cylinder continues to rotate, and then when released, the object and shaft again rotate with the cylinder.

11. The method of claim 10 further comprising the step of disposing a low friction interface within the second hollow between the cylinder and the shaft such that the shaft is carried and rotated by the cylinder in communication with the low friction interface.
